(19) United States
(12) Patent Application Publication
(10) Pub. No.: US 2009/0114513 A1
(43) Pub. Date: May 7, 2009

(54) MICRO ELECTROMECHANICAL SYSTEM (MEMS) SWITCH

(75) Inventors: Chul-soo Kim, Hwaseong-Si (KR); Byeoung-ju Ha, Seognam-Si (KR); In-sang Song, Seoul (KR); Duck-hwan Kim, Goyang-Si (KR); Yun-kwon Park, Dongducheon-Si (KR); Jea-shik Shin, Suwon-Si (KR)

Correspondence Address: DLA PIPER LLP US, P. O. BOX 2758, RESTON, VA, 20195, US

(73) Assignee: SAMSUNG ELECTRO-MECHANICS CO, LTD., Suwon-Si (KR)

(21) Appl. No.: 12/102,442

(22) Filed: Apr. 14, 2008

(30) Foreign Application Priority Data
Nov. 1, 2007 (KR) 2007-111026

(51) Int. Cl. H01H 57/00

(52) U.S. Cl. 200/181

(57) ABSTRACT

A Micro ElectroMechanical System (MEMS) switch is provided. The MEMS switch includes a ground, a moving unit moveable according to a driving signal, for connecting the input to the output or disconnecting the input from the output, and an electrode unit arranged in the configuration of a protrusion formed on a portion of the round, to induce a leakage signal generated between the input and the output to move toward the ground.

### CROSS-REFERENCE TO RELATED APPLICATIONS

This application claims the benefit under 35 U.S.C. §119 of Korean Patent Application No. 2007-111026, filed on Nov. 1, 2007, in the Korean Intellectual Property Office (KIPO), the entire disclosure of which is hereby incorporated by reference.

### BACKGROUND OF THE INVENTION

1. Field of the Invention

The present invention relates to a Micro ElectroMechanical System (MEMS) switch, and more particularly, to an MEMS switch for improving isolation characteristics.

2. Description of the Related Art

The Micro ElectroMechanical System (MEMS) generally relates to processing micro switches, mirrors, sensors or precision mechanic parts using semiconductor processing techniques. Combined with the semiconductor technology, which provides advantages such as precision processing, inter-product conformity, and high productivity, the MEMS technology is recognized for its enhanced performance and reduced price.

A MEMS switch is one of the most widely fabricated elements incorporating the MEMS technology. The MEMS switch is widely used in a wireless communication terminal operating in microwaves or millimeter band, or for a selective signal transmission of a system or an impedance matching circuit.

A conventional MEMS switch generally consists of a driving unit and a switch unit. The driving unit is driven by electromagnetic force to switch on/off the switch unit. The switch unit includes a moving unit to move according to the driving unit, and an input/output connected to or disconnected from each other according to the moving unit.

Recently, as ultra-small MEMS switches have been available, the input and output have a reduced interval therebetween. Accordingly, the input and output have problem of direct leakage. The input and output also have the leakage problem even in the switch off state due to short distance therebetween.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a

The above objects of the present invention are substantially realized by providing a Micro ElectroMechanical System (MEMS) switch having an electrode to induce leakage signal toward a ground so as to reduce a leakage of signal.

According to an aspect of the present invention, a Micro ElectroMechanical System (MEMS) switch for connecting an input and an output, is provided. The MEMS switch may include a ground, a moving unit moveable according to a driving signal, for connecting the input to the output or disconnecting the input from the output, and an electrode unit arranged in the configuration of a protrusion formed on a portion of the ground, to induce a leakage signal generated between the input and the output to flow toward the ground.

The electrode unit may be arranged on the ground between the ground and the moving unit, to contact the moving unit when the moving unit is separated from between the input and the output.

The electrode unit may include a plurality of electrodes.

The electrode unit may include a first electrode arranged on the ground between the ground and the moving unit, to contact the moving unit when the moving unit is separated from between the input and the output, and a second electrode unit connected to the moving unit to move together, and arranged between the input and the output to induce a leakage signal generated between the input and the output to flow toward the ground.

The MEMS switch may further include a secondary electrode unit connected to the moving unit to move together, and arranged between the input and the output to induce a leakage signal generated between the input and the output to flow toward the ground.

The electrode unit may be arranged on the ground between the ground and the moving unit, to contact the moving unit when the moving unit is separated from between the input and the output.

The electrode unit may be arranged between the input and the output to induce a leakage signal generated between the input and the output to flow toward the ground.

Other objects, advantages and salient features of the invention will become apparent to those skilled in the art from the following detailed description, which, taken in conjunction with the annexed drawings discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 illustrates the structure of a Micro ElectroMechanical System (MEMS) switch according to an exemplary embodiment of the present invention;

FIGS. 2A and 2B illustrate switch units to explain the operation of an MEMS switch according to an exemplary embodiment of the present invention;

FIGS. 3 to 5 illustrate switch units according to a variety of exemplary embodiments of the present invention; and

FIG. 6 is a graphical representation of an isolation characteristic of an MEMS switch according to an exemplary embodiment of the present invention.

### DETAILED DESCRIPTION OF THE PREFERRED EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

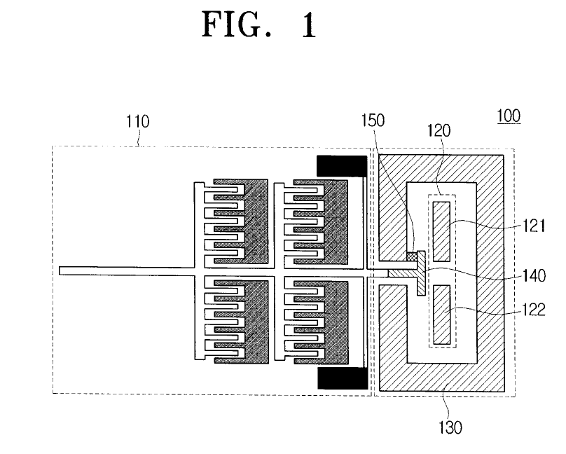

FIG. 1 illustrates the structure of Micro a ElectroMechanical System (MEMS) switch according to an exemplary embodiment of the present invention.

Referring to FIG. 1, the MEMS switch includes a driving unit 110, an input/output 120, a ground 130, a moving unit 140, and an electrode unit 150.

The driving unit 110 causes the moving unit 140 to move according to a driving signal, to connect the input 121 to the output 122 or disconnect the input 120 from the output 122. Specifically, the driving unit 110 moves a moveable beam, using an electromagnetic force generated between a fixed electrode and a driving electrode and is applied according to an external control signal. The moveable beam is connected to the moving unit 140 to cause the moving unit 140 to move.

The input/output 120 includes an input 121 and an output 122. When the switch is in on state, a signal received via the input 121 is output via the output 122. The distance between the input 121 and the output 122 may be adjusted appropriately.

The electrode unit 150 may be arranged in the configuration of a protrusion formed on one side of the ground 130, to induce a leakage signal between the input 121 and the output 122 towards the ground 130. The electrode unit 150 may be arranged between the ground 130 and the moving unit 140, and formed on the ground 130. Specifically, the electrode unit 150 may be arranged as a protrusion formed on a portion of the ground 150 to cause the moving unit 140 to be grounded when the switch is turned off.

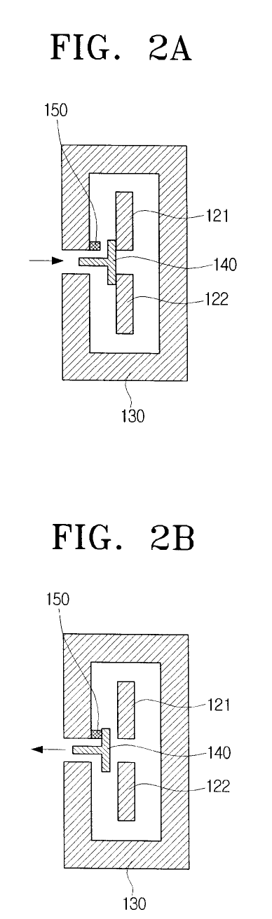

The moving unit 140 may connect the input 121 to the output 122 or disconnect the input 121 from the output 122 according to the movement of the driving unit 110. The operation of the moving unit 140 will be explained in detail below, with reference to FIGS. 2A and 2B.

FIGS. 2A and 2B are views provided to explain the operation of an MEMS switch according to an exemplary embodiment of the present invention. FIG. 2A illustrates an MEM switch in on state.

Referring to FIG. 2A, as the driving unit 110 is driven by the electromagnetic force, the moving unit 140, connected to the driving unit 110, is moved gradually toward a contact with the input/output 120. As the moving unit 140 is connected to the input 121 and the output 122, a signal from the input 121 can be sent to the output 122 via the moving unit 140.

FIG. 2B illustrates an MEMS switch in off state. Referring to FIG. 2B, the moving unit 140 is moved to the ground 130 according to the driving of displacement transmitted from the driving unit 110. As a result, the moving unit 140 is separated from the input/output 120, thereby cutting off the signal of the input 121 from being transmitted to the output 122. The moving unit 140 may continue moving after the separation from the input/output 120 and be connected to the electrode unit 150.

As a result, the moving unit 140 is grounded via the electrode unit 150, thereby forming an isolation characteristic according to which a leakage signal of the input 121, if leaks to the moving unit 140, is flowed to the ground 130 without being transmitted to the output 122. Furthermore, since the electrode unit 150 is formed between the ground 130 and the moving unit 140, the operating distance of the moving unit 140 is decreased, and the driving voltage of the MEMS switch 100 is decreased.

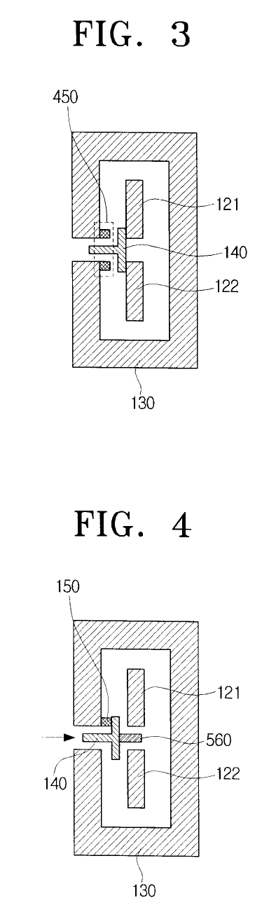

FIGS. 3 to 5 illustrate switch units according to a variety of exemplary embodiments of the present invention.

Referring to FIG. 3, a plurality of electrode units 450 are provided, arranged in the configuration of protrusions formed on a side of the ground 130 to contact the moving unit 140. Since a plurality of electrodes connects both sides of the moving unit 140, more stable ground structure is provided.

Referring to FIG. 4, the MEMS switch may additionally include a secondary electrode 560. The secondary electrode 560 is connected to the moving unit 140 to move together, and is arranged between the input 121 and the output 122 to induce a leakage signal between the input 121 and the output 122 toward the ground 130. Specifically, the secondary electrode 560 may be formed on a front-end of the moving unit 140 to prevent a direct leakage of a signal between the input 121 and the output 122 when the switch 100 is in off state.

FIG. 5 illustrates another example in which a plurality of electrodes is provided, according to an exemplary embodiment of the present invention.

Referring to FIG. 5, the electrode unit may include a first electrode unit 150 and a second electrode unit 660. The first electrode unit 150 may be formed on the ground 130 between the ground 130 and the moving unit 140. The first electrode unit 150 contacts the moving unit 140 when the moving unit 140 is separated from between the input 121 and the output 122. The second electrode 660 is arranged between the input 121 and the output 122 to induce a leakage signal between the input 121 and the output 122 toward the ground 130. According to the structure as explained above, the isolation characteristic is further improved while the MEMS switch 100 is in off state.

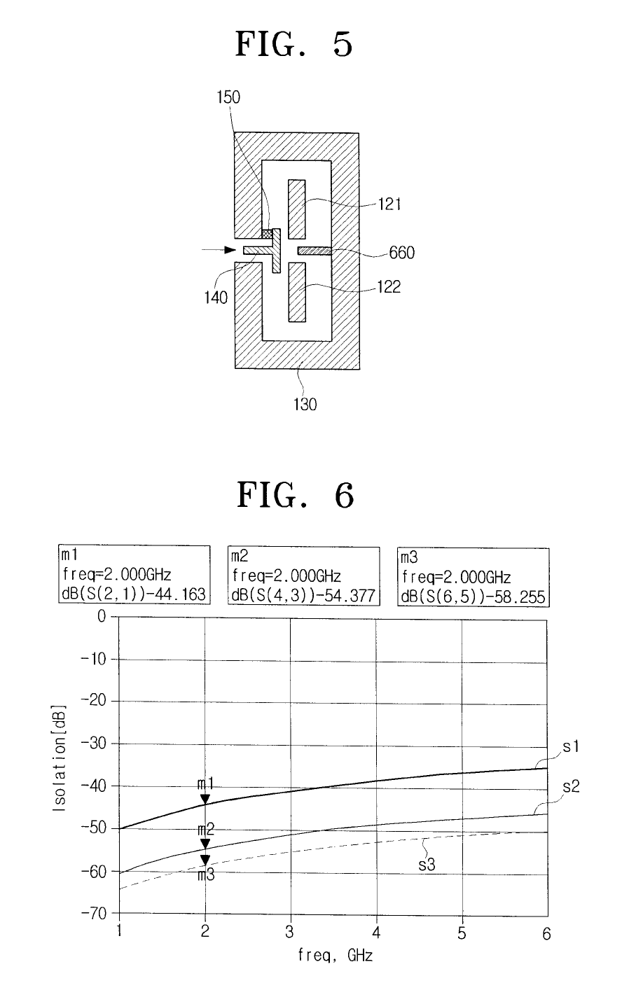

FIG. 6 is a graphical representation of an isolation characteristic of an MEMS switch according to an exemplary embodiment of the present invention.

A line S1 of the graph represents the conventional isolation characteristic, a line S2 represents the isolation characteristic of an MEMS switch of FIG. 1 according to an exemplary embodiment of the present invention, and a line S3 represents the isolation characteristic of an MEMS switch of FIG. 4 according to another exemplary embodiment of the present invention. Referring to the graphical representation of FIG. 6, a conventional MEMS switch, operating with 2 GHz, has −44.163 dB, while the MEMS switches according to the exemplary embodiments of the present invention have −54.377 dB and −58.255 dB, showing more than 10 dB of enhancement.

While the present invention has been shown and described with reference to certain exemplary embodiments thereof, it will be understood by those skilled in the art that various changes in form and details may be made therein without departing from the sprit and scope of the invention as defined by the appended claims and their equivalents.

What is claimed is:

1. A Micro ElectroMechanical System (MEMS) switch for connecting an input and an output, the MEMS switch comprising:
a ground;
a moving unit moveable according to a driving signal, for connecting the input to the output or disconnecting the input from the output; and
an electrode unit arranged in the configuration of a protrusion formed on a portion of the ground, to induce a leakage signal generated between the input and the output to flow toward the ground.

2. The MEMS switch of claim 1, wherein the electrode unit is arranged on the ground between the ground and the moving unit, to contact the moving unit when the moving unit is separated from between the input and the output.

3. The MEMS switch of claim 2, wherein the electrode unit comprises a plurality of electrodes.

4. The MEMS switch of claim 1, wherein the electrode unit comprises:
a first electrode arranged on the ground between the ground and the moving unit, to contact the moving unit when the moving unit is separated from between the input and the output; and
a second electrode unit arranged between the input and the output to induce a leakage signal generated between the input and the output to flow toward the ground.

5. The MEMS switch of claim 1, further comprising a secondary electrode unit connected to the moving unit to move together, and arranged between the input and the output to induce a leakage signal between the input and the output toward the ground.

6. The MEMS switch of claim 5, wherein the electrode unit is arranged on the ground between the ground and the moving unit, to contact the moving unit when the moving unit is separated from between the input and the output.

7. The MEMS switch of claim 1, wherein the electrode unit is arranged between the input and the output to induce a leakage signal generated between the input and the output to flow toward the ground.
